(19) United States
(12) Patent Application Publication
(10) Pub. No.: US 2010/0289625 A1
(43) Pub. Date: Nov. 18, 2010

(54) RFID TAG APPARATUS AND AUTHENTICATION METHOD THEREOF

(75) Inventors: Ji-Man Park, Daejeon-city (KR); Young-Soo Park, Daejeon-city (KR); Young-Sae Kim, Daejeon-city (KR); Sung-Ik Jun, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunucations Research Institute, Daejeon (KR)

(21) Appl. No.: 12/093,642

(22) PCT Filed: Dec. 6, 2006
(86) PCT No.: PCT/KR06/05249

§ 371 Date: May 14, 2008

(30) Foreign Application Priority Data
Dec. 7, 2005 (KR) 10-2005-0118785
Aug. 10, 2006 (KR) 10-2006-0075804

(51) Int. Cl. H04Q 5/22

(52) U.S. Cl. 340/10.42

(57) ABSTRACT

Provided is a radio frequency identifier (RFID) tag apparatus and an authentication method thereof. The RFID tag apparatus includes a device, a device recognizing unit, an RF processor, and a controller. The device receives a first signal and outputs a second signal in response to the first signal. The device recognizing unit outputs the first signal to the device in response to control signal and receives the second signal to output n-bit data, where n is an integer greater than 1. The RF processor receives an RF signal and extracts information from the RF signal. The controller outputs the control signal to the device recognizing unit in response to the information and processes the n-bit data in response to the information.

### TECHNICAL FIELD

The present invention relates to a radio frequency identifier (RFID) tag device and an authentication method for the same, and more particularly, to an RFID tag apparatus which can be used for authentication and anti-hacking and which can measure conditions of the surrounding environment, and an authentication method for the same.

### BACKGROUND ART

An RFID is a chip attached with an antenna. Data stored in the chip can be wirelessly transmitted the antenna. The RFID tag may be used in various fields such as product identification and vehicle identification. An RFID tag attached to a product includes data regarding the product and a purchaser. The RFID tag may be embedded onto packaging of the product, a library book, a credit card, an identification card, a driver's license, or a passport. Product management can be conveniently achieved using the RFID tag attached to a product in a store or a warehouse, or a rack support of the product. Moreover, the RFDIG tag may be embedded in an electronic toll pass or a key chain.

Authentication is required so as to avoid not only illegal use of an identification service of the RFID tag but also counterfeiting and modification of the RFID tag.

### DISCLOSURE OF INVENTION

### Technical Problem

The present invention provides a radio frequency identifier (RFID) tag apparatus including an authentication module in order protect RFID tag information therein and measure conditions of the surrounding environment such as temperature or moisture, and an authentication method for the same.

### Technical Solution

According to an aspect of the present invention, there is provided an RFID tag apparatus including a device, a device recognizing unit, an RF processor, and a controller. The device receives a first signal and outputs a second signal in response to the first signal. The device recognizing unit outputs the first signal to the device in response to a control signal and receives the second signal to output n-bit data, where n is an integer greater than 1. The RF processor receives an RF signal and extracts information from the RF signal. The controller outputs the control signal to the device recognizing unit in response to the information and processes the n-bit data in response to the information.

According to another aspect of the present invention, there is provided a method for authenticating an RFID (radio frequency identifier) tag including a device adapted to receive a first signal and output a second signal in response to the first signal. In the method, the first signal is output to the device. The second signal is received from the device to generate n-bit data, where n is an integer greater than 1. The n-bit data is compared with n-bit data stored in the storage unit to perform authentication.

### Advantageous Effects

According to the present invention, the security of the RFID tag is intensified by authenticating the RFID tag using device values output from a device internally or externally provided to the RDIF tag. It is also possible to determine whether a product to which the RFID tag is attached is genuine or whether the product to which the RFID tag is attached is damaged.

In addition, the device values output from the device including environmentally sensitive elements and internally or externally provided to the RFID tag may be used to determine whether a system internally and externally including the aforementioned device is secure against the surrounding environment.

### DESCRIPTION OF DRAWINGS

The above and other features and advantages of the present invention will become more apparent by describing in detail exemplary embodiments thereof with reference to the attached drawings in which:

FIG. 1 is a block diagram illustrating an internal configuration of a radio frequency identifier (RFID) tag according to an embodiment of the present invention;

FIG. 2 illustrates a schematic configuration of a communication including the RFID tag illustrated in FIG. 1;

FIGS. 3A to 3E are exemplified circuit diagrams of a device recognizing unit and a device illustrated in FIG. 1;

FIG. 4 illustrates a signal S_en output from a controller illustrated in FIG. 1, a voltage signal varying according to the signal S_en, and other signals;

FIGS. 5A to 5D illustrate various configurations of an analog signal processor (ASP), a digital logic processor (DLP), and a latch;

FIGS. 5E and 5F are exemplified circuit diagrams including two ASPs and one DLP;

FIG. 5G illustrates waveforms of operation signals output froma circuit illustrated in FIG. 5F;

FIG. 6A illustrates flowchart of operations of a device recognizing unit, a controller, and a storage unit when the RFID tag illustrated in FIG. 1 is issued;

FIGS. 7A and 7B illustrate embodiments when one or more devices are outside the RFID chip, respectively; and

FIGS. 8A and 8B illustrate embodiments when one or more devices are inside the RFID chip, respectively.

### MODE FOR INVENTION

Hereinafter, the present invention will be described in detail by explaining exemplary embodiments of the invention with reference to the attached drawings.

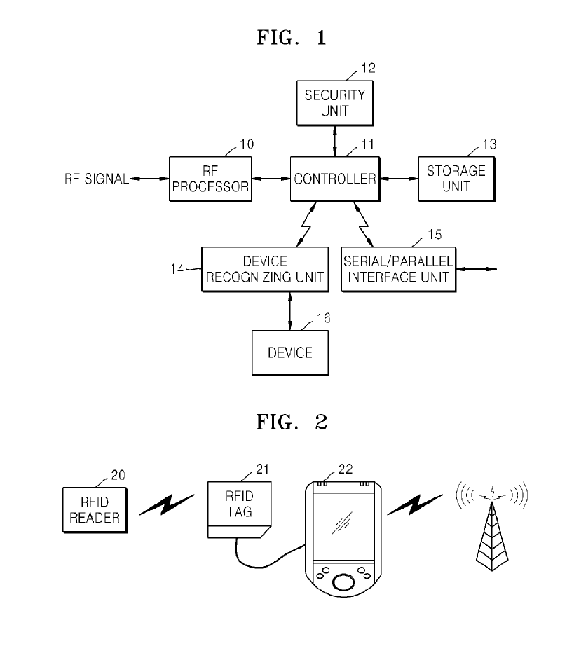

FIG. 1 is a block diagram illustrating an internal configuration of a radio frequency identifier (REID) tag according to an embodiment of the present invention.

The RFID tag includes an RF processor 10, a controller 11, a security unit 12, a storage unit 13, and a device recognizing unit 14. A device 16 connected to the device recognizing unit 14 is internally or externally provided to the RFID tag. A serial/parallel interface unit 15 may be included in the RFID tag.

The RF processor 10 converts a received RF signal into digital data and extracts information contained in the RF signal. The RF processor 10 also converts necessary data into an RF signal to be transmitted. The controller 11 controls operations of respective elements. The security unit 12 decrypts the information extracted from the RF signal or encrypts data to be transmitted in an RF signal, for the data security. Various memories such as a read-only memory (ROM), a random-access memory (RAM), and an electrically erasable programmable read-only memory (EEPROM) may be used as the storage unit 13 depending on whether the controller 11 is a central processing unit (CPU). The storage unit 13 stores data used in encryption/decryption and an operation system of an RFID tag executed by the controller 11. The device recognizing unit 14 outputs data by using a signal output from the device 16 which is internally or externally provided to the RFID tag. The device 16 may be implemented with sensor devices which output values that vary depending on the external environments, or of which output fixed values regardless of the external environments. The serial/parallel interface unit 15 transmits data output from the device recognizing unit 14 to a mobile terminal such as a mobile phone or a personal digital assistant, or receives data from the mobile terminal.

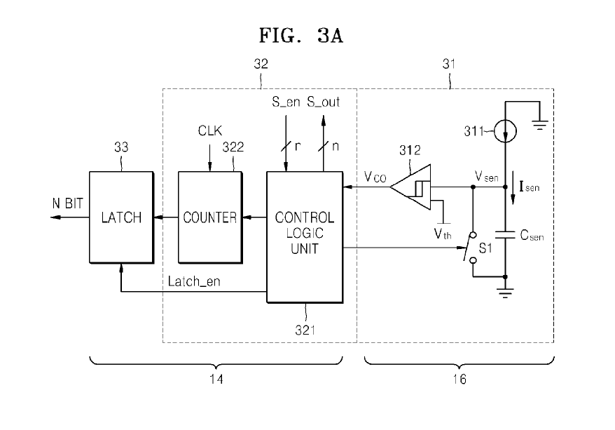

FIG. 2 illustrates a schematic configuration of a communication system including the RFID tag illustrated in FIG. 1.

Referring to FIG. 2, an RFID reader 20 communicates with the RFID tag 21, authenticates identification information stored in the RFID tag 21 and performs encryption and decryption for information required to communicate with the RFID tag 21. The RFID reader 20 may further include a display (not shown) so that a user can visually check identification information and anti-counterfeit information of the RFID tag 21. The RFID reader 20 may further include function keys (not shown) for selecting various functions such as communication with an external device.

The RFID tag 21 may be directly connected to a mobile terminal 22 the serial/parallel interface unit 15 as shown in FIG. 1, in order to provide information obtained through communication with the device recognizing unit 14 or the RFID reader 20 to the mobile terminal 22 in real time. In particular, the RFID tag 21 may output a value detected by the device recognizing unit 14 to the mobile terminal 22 and may receive a response to the value from the mobile terminal 22. Furthermore, the mobile terminal 22 may transmit information obtained from the RFID tag 21 to a desired destination through a wireless network 23. A value output from the device recognizing unit 14 may be used to authenticate or measure the RFID tag 21.

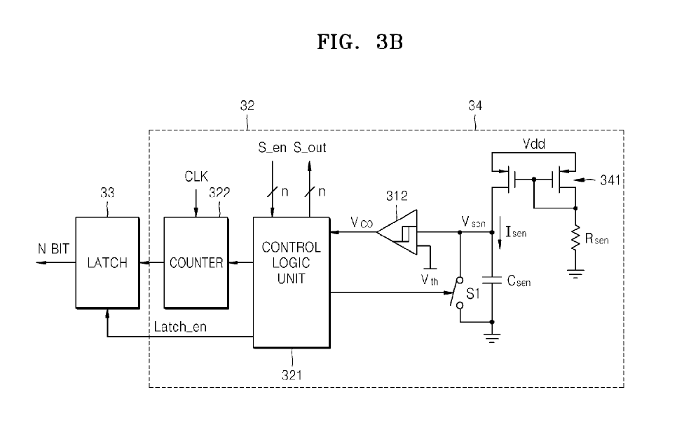

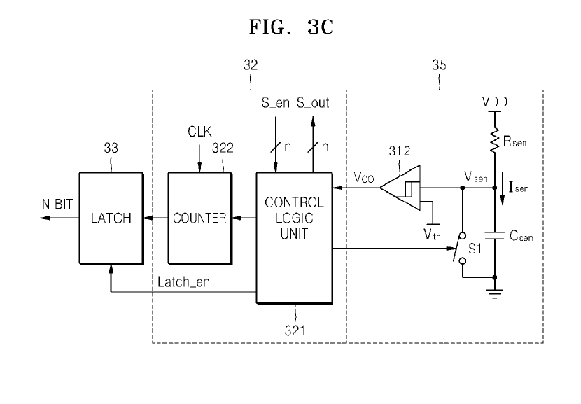

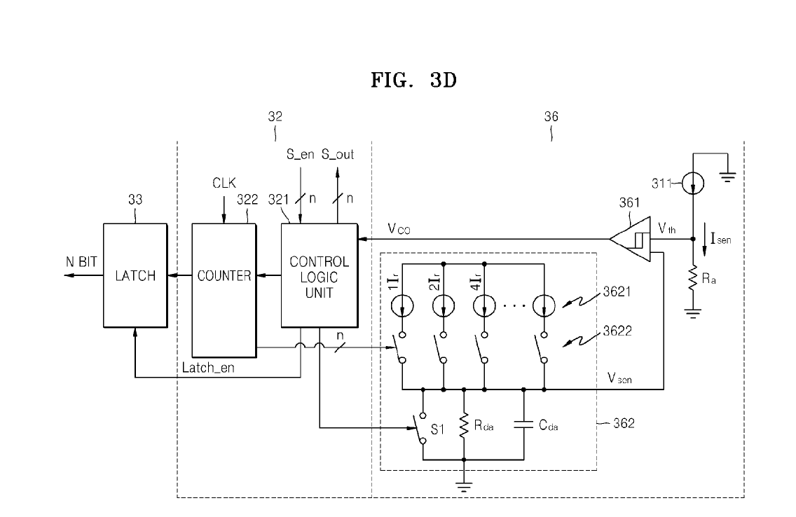

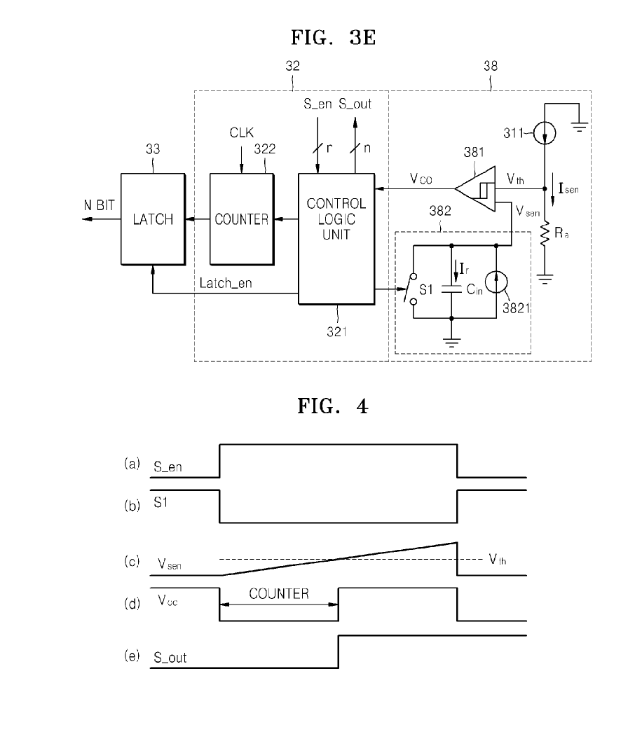

FIGS. 3A to 3E are exemplified circuit diagrams of the device recognizing unit 14 and the device 16 illustrated in FIG. 1. Elements having identical reference numerals in the drawings operate in the same manner. Thus, for convenience, repeated descriptions will be omitted.

Referring to FIG. 3A, the device recognizing unit 14 includes a digital logic processor (DLP) 32 and a latch 33. Referring to FIG. 3A, the device 16 is an analog signal processor (ASP) 31 including analog-type devices.

The ASP 31 includes a current source 311, a switch S1, a capacitor Csen, and a comparator 312. The switch 51 is turned on/off in response to a control signal output from the DLP 32. When the switch S1 is turned off, the capacitor Csen is charged by a current Isen generated by the current source 311. If a charge voltage Vsen is greater than a threshold voltage Vth, an output of the comparator 312 is shifted from a first level to a second level. Here, the comparator 312 may be a Schmitt trigger.

The DLP 32 includes a control logic unit 321 and a counter 322.

The control logic unit 321 receives a control signal S_en from the controller 11 illustrated in FIG. 1 to output a turn-off signal to the switch S1, and outputs a count enable signal to the counter 322. Furthermore, the control logic unit 321 outputs a latch enable signal latch_en to the latch 33. When an output Vco of the comparator 312 is shifted from the first level to the second level, a signal S_out is output to the controller 11 to inform the controller 11 of the completion of the operation of the device recognizing unit 14.

The counter 322 is an n-bit counter starts counting in response to the count enable signal and continues the counting until a count disable signal is received. The latch 33 latches and outputs a count value output from the counter 322 in response to a latch enable signal.

FIG. 4 illustrates the signal S_en output from the controller 11 illustrated in FIG. 1, a voltage signal varying according to the signal S_en, and other signals.

FIG. 4A illustrates the signal S_en. FIG. 4B illustrates a signal input to the switch S1. FIG. 4C illustrates a voltage Vsen charged in a capacitor Csen. FIG. 4D illustrates a signal Vco output from the comparator 312. FIG. 4E illustrates a signal S_out output to the controller 11. Referring to FIGS. 4A to 4E, when the controller 11 outputs the signal S_en a high level, the control logic unit 321 outputs a switch-off signal to the switch S1. Sequentially, charging is started in the capacitor Csen, and the control logic unit 321 outputs a count start signal to the counter 322. While the charge voltage Vsen of the capacitor Csen is less than a threshold voltage Vth, the counter 322 continues counting according to a clock CLK. If the charge voltage Vsen is greater than the threshold voltage Vth, the voltage Vco is shifted from a low level to a high level. Thus, the control logic unit 321 outputs a signal to stop counting. The control logic unit 321 also outputs the signal S_out to the controller 11 to inform that the operation of the device recognizing unit 14 is completed.

The latch 33 latches a value obtained from the counting to the controller 11.

FIG. 3B is another exemplified circuit diagram of the device recognizing unit 14 and the device 16. In FIG. 3B, the operation of the DLP 32 is the same as the operation of the DLP 32 illustrated in FIG. 3A, while the configuration and operation of an ASP 34 are different from those of the ASP 31 illustrated in FIG. 3A.

In the ASP 34, a current Isen flowing through a capacitor Csen is generated by a current mirror 341 connected to a supply voltage Vdd.

FIG. 3C is still another exemplified circuit diagram of the device recognizing unit 14 and the device 16. In FIG. 3C, the operation of the DLP 32 is the same as the operation of the DLP 32 illustrated in FIG. 3A, while, the configuration and operation of an ASP 35 are different from those of the ASP 31 illustrated in FIG. 3A.

In the ASP 35, a current Isen flowing through a capacitor Csen is equal to a current flowing through a resistor Rsen connected to a supply voltage Vdd.

FIG. 3D is still another exemplified circuit diagram of the device recognizing unit 14 and the device 16. In FIG. 3D, the operation of the DLP 32 is the same as the operation of the DLP 32 illustrated in FIG. 3A, while the configuration and operation of an ASP 36 are different from those of the ASP 31 illustrated in FIG. 3A.

In the ASP 36, a reference voltage Vth of a comparator 361 is determined to be a voltage across a resistor Ra when a current Isen generated by a current source 311 flows through the resistor Ra. A voltage Vsen input to the comparator 361 is generated by an n-bit count value (where n is an integer greater than 1) output from a counter 322 of the ASP 36.

The operation of the ASP 36 will now be described in detail. A Vsen generator 362 includes n current sources 3621, n switches 3622, a switch S1, a resistor Rda, and a capacitor Cda. Here, only either the resistor Rda or the capacitor Cda may be included in the Vsen generator 362.

The n current sources 3621 generate a current Ir that sequentially increases from a least significant bit (LSB) in response to the n-bit count value. Each of the n switches 3622 is turned on/off by the n bit count value of the counter 322. When the switch S1 is turned off in response to a control signal of the control logic unit 321, the capacitor Cda is charged through switches turned on according to the n-bit count value among the n switches 3622. The charged voltage is supplied to the comparator 361 as Vsen. The same applied when the resistor Rda is excluded. Meanwhile, when only the resistor Rda is included, a voltage across the resistor Rda when a current flows through the resistor Rda is supplied to the comparator 361 as Vsen.

FIG. 3E is still another exemplified circuit diagram of the device recognizing unit 14 and the device 16. In FIG. 3E, the operation of the DLP 32 is the same as the operation of the DLP 32 illustrated in FIG. 3A, while the configuration and operation of an ASP 38 are different from those of the ASP 31 illustrated in FIG. 3A.

In the ASP 38, a reference voltage Vth of the comparator 381 is determined as a voltage across the resistor Ra when a current Isen generated by the current source 311 flows through the resistor Ra. A voltage Vsen input to the comparator 381 is generated by a voltage generator 382.

The voltage generator 382 includes a current source 3821, a capacitor Cin, and a switch S1. When the switch S1 is turned off by a control signal output from the control logic unit 321, the capacitor Cin is charged by a current Jr generated by the current source 3821. The charged voltage is supplied to the comparator 381 as Vsen.

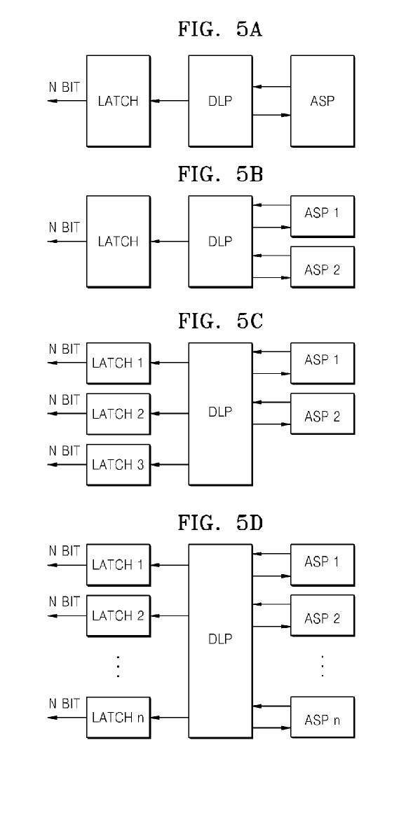

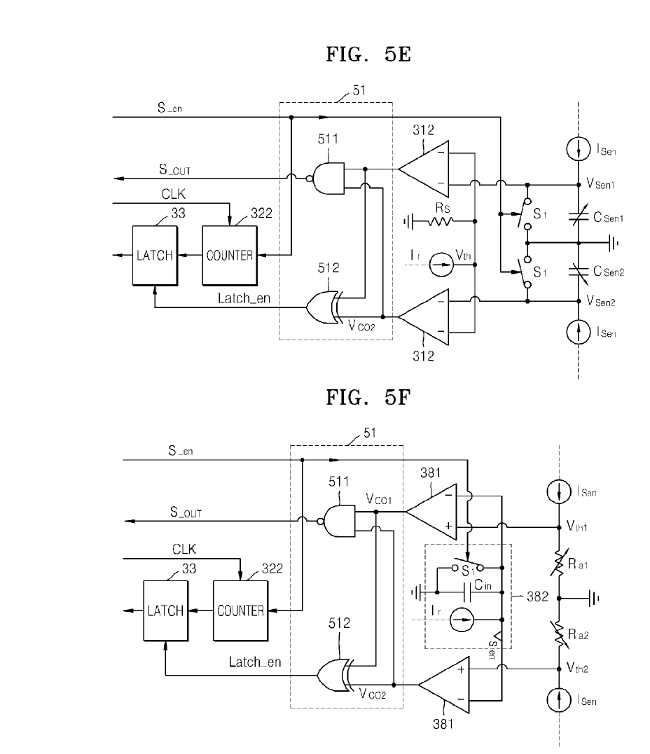

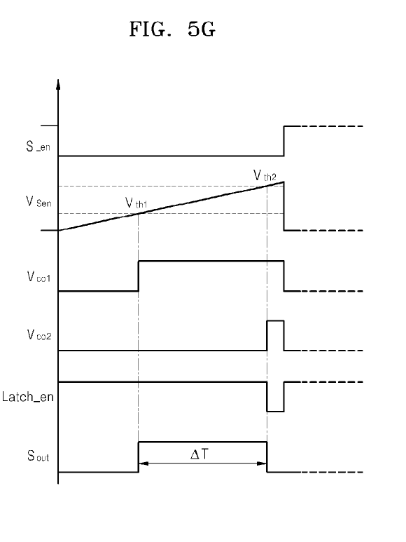

FIGS. 5A to 5D are block diagrams illustrating exemplified various structures of the ASP, the DLP, and the latch illustrated in FIGS. 3A to 3E.

FIG. 5A illustrates a structure having one ASP, one DLP, and one latch. FIG. 5B illustrates a structure having two ASPs, one DLP, and one latch. According to the structure illustrated in FIG. 5B, the DSP transmits a device value, which is recognized by the two ASPs, to the latch.

FIG. 5C illustrates a structure having two ASPs, one DLP, and three latches. According to the structure illustrated in FIG. 5C, the DSP outputs a device value, which is recognized by the two ASPs, to a latch 1 and a latch 2. The two values may be computed to be output to a latch 3.

FIG. 5D illustrates a structure having a plurality of ASPs, one DLP and a plurality of latches. According to the structure illustrated in FIG. 5D, the DSP stores device values recognized for the ASPs n latches.

The circuits illustrated in FIGS. 5A to 5D operate so that, when the number of ASPs and latches increases, the control logic unit and the counter of the DSP operate properly to output n-bit count values as many as the number of latches in response to a plurality of output signals from the comparators in the ASPs.

According to the structures illustrated in FIGS. 5A to 5D, when the device recognizing unit 14 is used as an authentication means, security of an RFID tag increases as the number of ASPs and latches increases.

FIGS. 5E and 5F are exemplified circuit diagrams including two ASPs and one DLP.

Referring to FIG. 5E, it is noted that the two ASPs are of the circuit of the ASP 35 illustrated in FIG. 3C whose Isen is supplied by a current source and Vth is supplied by the current source Ir and a resistor Rs. In the circuit shown in FIG. 5E, a control logic unit 51 may include a NAND gate 511 and an XOR gate 512 whose inputs are from the two comparator 312, respectively. Here, a capacitor Csen has a variable capacitance.

Referring to FIG. 5F, the two ASPs are of the circuit of the ASP 38 illustrated in FIG. 3E. Like in FIG. 5E, a control logic unit 51 may include a NAND gate 511 and an XOR gate 512 whose inputs are from the two comparator 312, respectively. A resistor Ra has a variable resistance.

FIG. 5G illustrates waveforms of operation signals output from a circuit illustrated in FIG. 5F. When a signal S_en becomes a low level, the switch S1 is turned off and then a charge voltage Vsen of the capacitor Cin is supplied to comparators 381 and 382. The comparators 381 and 382 compare the voltage Vsen to threshold voltages Vth1 and Vth2 respectively to output Vco1 and Vco2. The NAND gate 511 and the XOR gate 512 of the control logic unit 51 output signals S_out and Latch_en in response to input signals Vco1 and Vco2. Referring to FIG. 5G, the counter 322 performs counting for a time D T. The latch 33 latches and outputs an n-bit count value output from the counter 322 in response to the signal Latch_en.

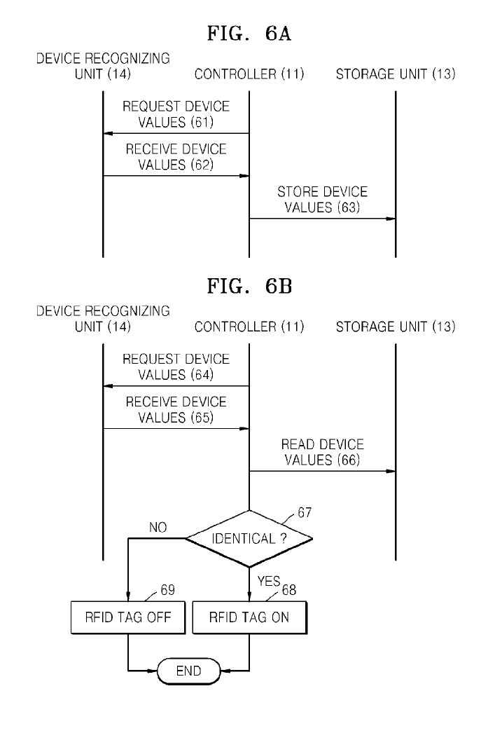

FIG. 6A illustrates flowchart of operations of the device recognizing unit 14, the controller 11, and the storage unit 13 when the RFID tag illustrated in FIG. 1 is issued.

First, the controller 11 requests device values to the device recognizing unit 14 (operation 61). In response to the request, the controller 11 receives the device values recognized by any one of the circuits illustrated in FIGS. 3A to 3E (operation 62). Referring to FIGS. 3A to 3E, the request of the device values is the same as outputting the signal S_en to the control logic unit 321. One or more device values may be received according to the structures illustrated in FIGS. 5A to 5D. The controller 11 stores the received device values in the storage unit 13 (operation 63).

FIG. 6B illustrates the flow of the process of authentication for the issued RFID tag.

First, the controller 11 requests device values to the device recognizing unit 14 (operation 64). In response to the request, the device values are received from the device recognizing unit 14 (operation 65). The controller 11 reads device values from the storage unit 14 (operation 66) and compares the read device values with the received device values (operation 67). If the two device values are identical, the RFID tag 21 is determined to be valid, and the RFID tag 21 is turned on be operated (operation 68).

If the two device values are not identical, the controller 11 determines that the RFID tag 21 is damaged by counterfeiting or the like. Then, the controller 11 stops the operation of the RFID tag 21 and turns off the RFID tag 21 (operation 69). In this operation, the RFID reader 20 can display the fact that the RFID tag 21 is turned off.

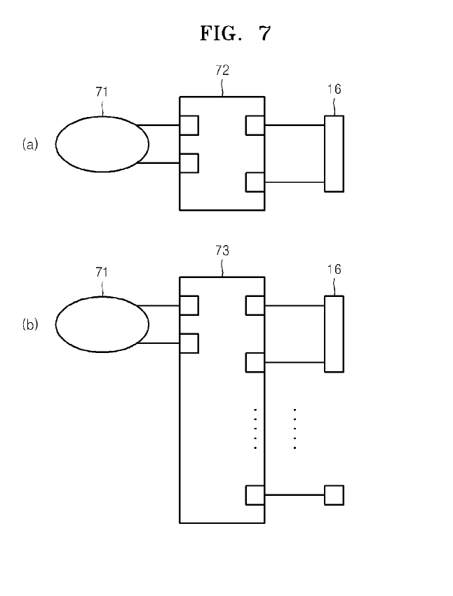

FIGS. 7(a) and 7(b) illustrate that one or more devices 16 are present outside REID tag chips 72 and 73. In FIGS. 7(a) and 7(b), the reference number 71 denotes an antenna.

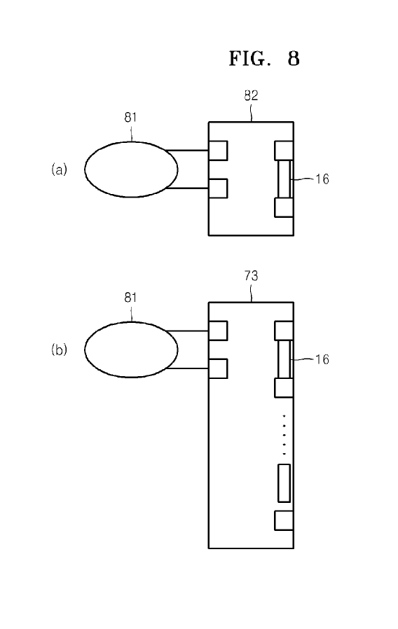

FIGS. 8(a) and 8(b) illustrate that one or more devices 16 are present inside RFID tag chips 82 and 83. In FIGS. 8(a) and 8(b), the reference number 81 denotes an antenna.

Here, as shown in FIGS. 3A to 3E, the device 16 may be a passive element type including a resistor and a capacitor or including an inductor. Alternatively, the device 16 may be an active element type including a transistor or a diode. When the device 16 is used for security and authentication, the device 16 includes passive elements, such as a resistor, a capacitor, or an inductor, which are not sensitive to the surrounding environment, obtain fixed device values. When the device 16 is used for measurement, the device 6 includes elements that are sensitive to the surrounding environment temperature, moisture, pressure, etc. so that the device values output from the device 6 can reflect the surrounding environment.

When an RFID tag is connected to the device 16 and attached to a product or when an RFID tag including the device 16 is attached to the product, it is effective to check whether the product is genuine or counterfeited. It is because the device 16 becomes useless when the device 16 is physically transformed or damaged.

1. An RFID (radio frequency identifier) tag apparatus comprising:
a device adapted to receive a first signal and outputs a second signal in response to the first signal;
a device recognizing unit adapted to output the first signal to the device in response to a control signal and receive the second signal to output n-bit data, where n is an integer greater than 1;
an RF processor adapted to receive an RF signal and extract information from the RF signal; and
a controller adapted to output the control signal to the device recognizing unit in response to the information and process the n-bit data in response to the information.

2. The RFID tag apparatus of claim 1, wherein the device is integrated or separately manufactured with the device recognizing unit, the RF processor, and the controller.

3. The RFID tag device of claim 1, wherein the device comprises:
a charging unit, a voltage across both ends of which increases in response to the first signal;
a current source adapted to supply a current to the charging unit; and
a comparator adapted to compare the voltage at the charging unit with a threshold voltage to output the second signal.

4. The RFID tag apparatus of claim 3, wherein the current source is a current mirror, one end of which is connected to a supply voltage and the other end is connected to the charging unit.

5. The RFID tag apparatus of claim 3, wherein the current source is a resistor, one end of which is connected to a supply voltage and the other end is connected to the charging unit.

6. The RFID tag apparatus of claim 3, wherein the charging unit comprises:
a switch adapted to be turned off in response to the first signal; and
an element adapted to be connected to the switch in parallel, a voltage across both ends which increases when the switch is turned off.

7. The RFID tag apparatus of claim 3, wherein the comparator is a Schmitt trigger adopting the threshold voltage as a reference voltage and the voltage at the charging unit as an input voltage.

8. The RFID tag apparatus of claim wherein the device comprises:
a charging unit, a voltage across both ends of which increases in response to the first signal;
a threshold voltage generator adapted to generate a threshold voltage; and
a comparator adapted to compare the threshold voltage with a voltage input from the charging unit to output the second signal.

9. The RFID tag device of claim 1, wherein the device recognizing unit comprises:
a control logic unit adapted to output the first signal to the device in response to the control signal and output a third signal in response to the second signal;
a counter adapted to perform counting in response to the third signal to output n-bit data; and
a latch adapted to latch and output the n-bit data.

10. The RFID tag apparatus of claim 9, further comprising:
a plurality of the devices; and
a plurality of the latches,
wherein the control logic unit outputs a plurality of the third signals in response to a plurality of the second signals output from the devices, the counter outputs the n-bit data in response to the third signals, and the latches latch and output the n-bit data output from the counter.

11. The RFID tag apparatus of claim 9, wherein the device comprises:
a charging unit, a current of which is controlled by the n-bit data output from the counter, and a voltage across both ends of which is increased by the current in response to the first signal;
a threshold voltage generator adapted to generate a threshold voltage; and
a comparator adapted to compare the threshold voltage with a voltage input from the charging unit to output the second signal.

12. The RFID tag apparatus of claim 11, wherein the charging unit comprises:
n current sources adapted to generate currents different from each other;
n switches each one end of which is connected to each of the current sources and adapted to be turned on/off according to each bit value of the n-bit data; and
an element adapted to be connected to the current sources through the switches and a voltage across both ends of which increases in response to the first signal.

13. The RFID tag apparatus of claim 1, further comprising a serial or parallel interface unit adapted to be connected to an external mobile terminal and transfer device values output from the device recognizing unit to the mobile terminal.

14. The RFID tag apparatus of claim 1, further comprising a storage unit, wherein the controller stores device values output from the device recognizing unit in the storage unit.

15. The RFID tag apparatus of claim 14, wherein the controller reads the device values stored in the storage unit, compares device values output from device recognizing unit with the read device values, and stops operation of the device if the two compared device values are not identical.

16. The RFID tag apparatus of claim 2, wherein the device includes fixed elements or variable elements whose values vary depending on surrounding environment, and outputs the second signal according to operations of the fixed or variable elements in response to the first signal.

17. The RFID tag apparatus of claim 1, further comprising a security unit, wherein the security unit decrypts the information extracted from the RF signal to output to the controller, and encrypts the n-bit data to output to the controller.

18. A method for authenticating an RFID (radio frequency identifier) tag including a device adapted to receive a first signal and output a second signal in response to the first signal, the method comprising:
outputting the first signal to the device;
receiving the second signal from the device to generate n-bit data, where n is an integer greater than 1; and
comparing the n-bit data with n-bit data stored in the storage unit to perform authentication.

19. The method of claim 18, further comprising, when the RFID tag is issued before the outputting the first signal to the device:
outputting the first signal to the device;
receiving the second signal from the device to generate n-bit data; and
storing the n-bit data in the storage unit.
